(19) United States
(12) Patent Application Publication
(10) Pub. No.: US 2009/0271002 A1
(43) Pub. Date: Oct. 29, 2009

(54) System and Method for Remotely Controlling Electronic Devices

(76) Inventor: David Asofsky, Pleasantville, NY (US)

Correspondence Address: James David Johnson, P.A., 401 East Las Olas Boulevard, Suite 130-290, Fort Lauderdale, FL, 33301, US

(21) Appl. No.: 12/432,310

(22) Filed: Apr. 29, 2009

Related U.S. Application Data
(60) Provisional application No. 61/048,745, filed on Apr. 29, 2008.

(51) Int. Cl. G05B 19/02; G06F 17/00; G10L 15/00

(52) U.S. Cl. 700/3; 700/90; 704/275; 704/E15.001

(57) ABSTRACT

A system and method for monitoring and controlling electric devices and electronic devices connected to an automation system in a first location from a different and remote location. The system can include at least one electric or electronic device connected to an automation system, the automation system being communicatively linked to a computer. The computer can be connected to a server via a communications network. An access device can be used by a user to submit control instructions for the electric or electronic device to the server via the communications network. The server can transmit the control instructions to the computer, which can use control software to translate the control instructions into a form that is readable by the automation system, thereby controlling one or more features of the electric or electronic device.

### FIELD OF THE INVENTION

The invention relates to methods and systems for controlling electric and electronic devices. More particularly, the invention relates to methods and systems for remotely monitoring and controlling electric and electronic devices in a home or other building.

### BACKGROUND

Some traditional home security systems, alarm systems, medical monitoring systems and other home and person monitoring systems are capable of being remotely monitored and controlled by security service personnel, law enforcement, fire and rescue personnel, home owners and occupants, apartment tenants, or building owners and occupants. However, these systems do not permit dwelling home, apartment, and building owners and occupants to monitor and control these systems, electronics, electrical devices, and appliances located in these spaces. These electronic and electrical devices and systems may feature control functions including, but not limited to, power, volume, brightness, and other features capable of being turned on or off, tuned, or otherwise controlled or monitored. Conventional home control and monitoring systems are not designed to allow users to control all of these devices and systems using a single interface that can be accessed remotely and securely.

A need exists for a system that allows a user to monitor and control a plurality of electronic and electrical devices and systems from remote locations using a single point of access and control.

### SUMMARY

The invention relates to systems and methods for monitoring and controlling electric devices and electronic devices connected to an automation system in a first location from a different and remote second location. The system can include at least one electric or electronic device connected to an automation system, the automation system being communicatively linked to a computer. The computer can be connected to a server via a communications network. An access device can be used by a user to submit control instructions for the electric or electronic device to the server via the communications network. The server can transmit the control instructions to the computer, which can use control software to translate the control instructions into a form that is readable by the automation system, thereby controlling one or more features of the electric or electronic device.

The methods can be used to aggregate multiple home automation technologies, protocols and devices from one integrated interface thereby allowing for secure bidirectional access outside of the physical location where devices, protocols, and/or technologies are located.

The open and universal schema of the system can allow for easy and effective third party integration and adoption of remote access methods. The systems and methods of the invention can apply universal security protocol measures to all disparate systems, thus improving security Of the underlying automated devices. A translation module or software can be used to unify the control features and functions of disparate devices in a single location so that the system has the appearance of a one integrated product.

The systems and methods described herein are advantageous over conventional home monitoring systems in that the present invention can allow a user to access, monitor, and control multiple devices from a remote location using a single user account or point of access and control such as, for example, a personal account registered and accessible via a website or an interactive voice response system.

Accordingly, the invention features a system for remotely controlling automated devices. The system can include an automated device generating a first data stream, a computer to which the automated device can be communicatively connected, a communications network to which the computer can be communicatively connected, a server that can be communicatively connected to the communications network, and a control device that can be communicatively connected to the server via the communications network.

In another aspect, the invention features the automated device being selected from among an electrical device and an electronic device.

In another aspect, the invention features the computer including software to translate the first data stream transmitted to the computer by the automated device into a second data stream that is transmitted to the server via the communications network.

In another aspect, the invention features the server including communications software capable of receiving control instructions in a third data stream from the control device and transmitting the control instructions to the computer in a fourth data stream.

In another aspect, the invention features the computer including control software capable of translating the fourth data stream into a fifth data stream that is readable by the automated device.

In another aspect, the invention features the automated device being communicatively connected to the computer via an interface that is communicatively connected to the computer and that is capable of bidirectional transmission of the first and fourth data streams.

In another aspect, the invention features the automated device including an electronic automation device capable of receiving control instructions from the computer.

In another aspect, the invention features the automated device being selected from among at least one of the following: a lamp, a light fixture, a lighting system, a home security system, an alarm system, a thermostat, a climate control system, a refrigerator, a freezer, an oven, a stove, an electric range, a hot tub, a jacuzzi, a swimming pool, a pool heater, a dishwasher, an iron, a washing machine, a drying machine, any other suitable home appliance, a television, a DVD player, a CD player, a home stereo system, a radio, an alarm clock, an answering machine, a digital video recorder, a VCR, a security camera, a personal computer, a cable box, a receiver, a digital television receiver, an electronic door lock system, a garage door control system, a security gate system, a medical monitoring system, and a battery-powered device.

In another aspect, the invention features the control device being selected from among at least one of the following: a land-line telephone, a cellular telephone, a smart phone, a car navigation system, an interactive voice response system, a personal digital assistant, and a computer.

In another aspect, the invention features the communications network being selected from at least one of the group consisting of: an intranet, a virtual private network (VPN), a local area network (LAN), a wide area network (WAN), a global area network (GAN), the Internet, and a cellular telephone network.

The invention also features a system for remotely controlling and monitoring automated devices. The system can include an automated device generating a first data stream, a computer to which the automated device is communicatively connected, a communications network to which the computer is communicatively connected, and a server communicatively connected to the communications network. The system can further include an interactive voice response system communicatively connected to the server and capable of receiving and translating audio instructions into a second data stream that is transmittable to and readable by the server. The system can also feature a telecommunication control device communicatively connected to the interactive voice response system via the communications network and capable of receiving and transmitting audio instructions to the interactive voice response system.

In another aspect, the invention features the telecommunication control device being a fixed phone line, a cellular phone line, or a voice over internet protocol (VoIP) telephone.

The invention also features a method for remotely monitoring and controlling automated devices. The method can include the steps of: (a) communicatively connecting a device that includes an automation system to a computer co-located in a first location, wherein the computer features control software; (b) communicatively connecting the computer to a server via a communications network, the server being remotely located in a second location, wherein the server features communications software; (c) providing control instructions to the server using an access device that is communicatively connected to the server via the communications network; (d) transmitting the control instructions from the server to the computer using the communications software; (e) receiving the transmitted control instructions from the server by the computer; (f) analyzing the control instructions using the control software installed on the computer; and (g) instructing the automation system to activate or deactivate a control feature of the device.

Another method of the invention includes the step of using the access device to access a website featuring control features capable of controlling the device.

Another method of the invention includes the step of using the access device to access an interactive voice response system featuring control features capable of controlling the device.

Another method of the invention includes the step of monitoring a dwelling place remotely using the access device.

Another method of the invention includes the step of monitoring a building other than a dwelling place using the access device.

Another method of the invention includes the step of controlling a power supply setting of the device.

Another method of the invention includes the step of controlling a volume setting of the device.

Another method of the invention includes the step of controlling a brightness setting of the device.

Another method of the invention includes the step of controlling the timing of the device.

Another method of the invention includes the step of controlling a television channel setting of the device.

Another method of the invention includes the step of controlling a radio station setting of the device.

Another method of the invention includes the step of controlling a temperature setting of the device.

Another method of the invention includes the step of controlling a humidity setting of the device.

Another method of the invention includes the step of controlling a locking and unlocking of the device.

Unless otherwise defined, all technical terms used herein have the same meaning as commonly understood by one of ordinary skill in the art to which this invention belongs.. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a diagram of the system.

FIG. 2 is a schematic view of the system.

### DETAILED DESCRIPTION

The invention provides systems for remotely monitoring and controlling electronic and electric devices located in a home, dwelling unit, or other building or space. For purposes of convenience only, the systems and methods described herein will be referred to in connection with their usage in a home. The systems can be used to enable security systems within the home and to remotely monitor the home to ensure that the home is safe and secure from intrusions by unauthorized individuals, e.g., burglars, and from fire, wind and other damage and hazards. The systems can also be used to control power and other features such as, for example, power on/off and volume controls, of electric and electronic devices located within the home. For purposes of this application, electronic devices are those devices that feature electronic circuitry such as, for example, a home security system and digital video recorder, and electric (or electrical) devices are those devices that do not feature electronic circuitry such as, for example, a light fixture.

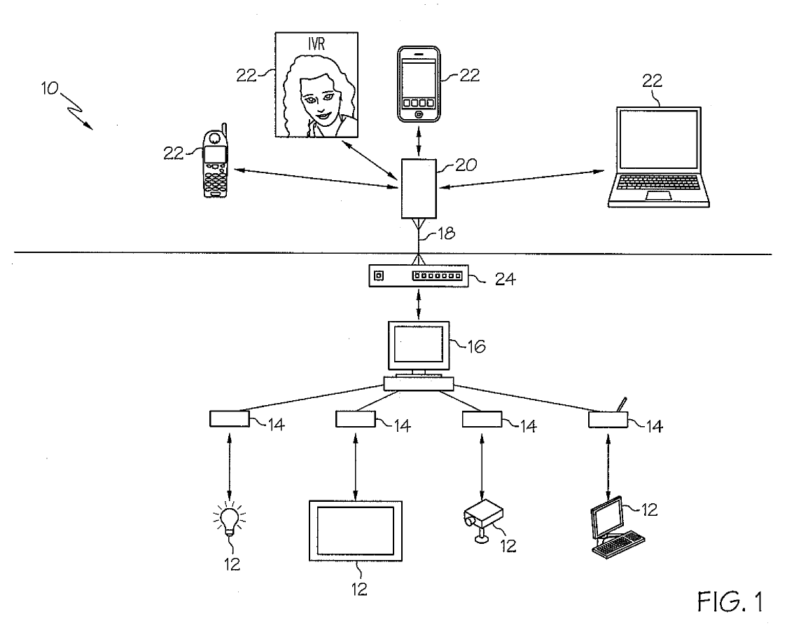

As shown in FIG. 1, the system 10 can include one or a plurality of automated devices 12 that include an electrical or electronic device connected to an electronic automation device 14. The electronic automation device can be capable of receiving control instructions from a computer 16.

In one embodiment, the automated device can feature an integrated electronic automation device. In another embodiment, the automated device and the electronic automation device can be separate and discrete components wherein the automated device can be connected to the electronic automation device via a power cord or other electrical or communicative linking means. The electronic automation device can be an interface capable of bidirectional transmission of data streams and can communicatively link the automated device to the computer. The automated device can be a lamp, a light fixture, a lighting system, a home security system, an alarm system, a thermostat, a climate control system, a refrigerator, a freezer, an oven, a stove, an electric range, a hot tub, a jacuzzi, a swimming pool, a pool heater, a dishwasher, an iron, a washing machine, a drying machine, any other suitable home appliance, a television, a DVD player, a CD player, a home stereo system, a radio, an alarm clock, an answering machine, a digital video recorder, a VCR, a security camera, a personal computer, a cable box, a receiver, a digital television receiver, an electronic door lock system, a garage door control system, a security gate system, and a medical monitoring system. In one embodiment, the battery-powered device can be a flood sensor, a door sensor such as those used to detect when a door is opened or closed, a window sensor such as those used to detect when a window is opened or closed, a temperature sensor, a flood detector, or a motion detector. The automated device can generate a first data stream.

The system can include a website, an interactive voice response system, or both. The system can incorporate the use of a XML data layer to create graphical controls, to enable data transfer to third party vendors, or for enabling utilization of the system with new and emerging technologies such as, for example, car navigation systems. A user can register to access the system so as to be able to control a plurality of automated electronic and electrical devices in a first location from a different and remote second location. Registration may be accomplished by submitting the user's personal information through a graphical user interface of the website, via the interactive voice response system, in person, by mail, by facsimile, or by any other suitable means for submitting the user's personal identifying information to the system service provider so that the service provider can establish an account, including a user name and password or pin code, for the user. The user can be a home, apartment or building owner or occupant. In another embodiment, the user can be a monitoring service paid for or hired by the home, apartment, or building owner or occupant.

The system can further include the computer 16, a communications network 18, a server 20, and one or more control devices 22. The computer can be a personal computer such as, for example, those intended for home or business use. The electronic automation device of each automated device can be communicatively connected to the computer. The computer can include a router 24, which can be an integrated router or a separate stand-alone router communicatively connected to both the computer and to the communications network. The computer can also include an integrated modem or a separate and stand-alone modem to communicatively connect the computer to the communications network.

In one embodiment, rather than a personal computer, the computer can be a gateway box to which the automated devices can be communicatively connected. As with embodiments in which the computer is a personal computer, the connection between the gateway box and the electronic automation device of each automated device can be wired, wireless, or virtual. The gateway box can include a subscriber identity module (SIM) card capable of communicating with the server via the communications network, e.g., a general packet radio service (GPRS) cellular network, and with the automated devices via the communicative linkage established between each automated device and the gateway box. In one embodiment, the gateway box can be a router or connected device.

The computer can be communicatively connected to the communications network. The computer can feature software installed thereon to translate the first data stream transmitted to the computer by the automated device into a second data stream that is transmitted by the computer to the server via the communications network. In embodiments in which the computer is a gateway box, the translation software can be installed on the gateway box without the need to include a separate personal computer.

The communications network can be an intranet, a local area network (LAN), a wide area network (WAN), a virtual private network (VPN), a cellular telephone network, or a global area network (GAN) such as, for example, the Internet. The protocols used by the system to transmit data can be wired or wireless technologies. In one exemplary embodiment, the system can transmit data streams via a broadband Internet connection. In another exemplary embodiment, the system can transmit data streams via a cellular telephone network. The communications network can be protocol independent so that the system can communicate over low-bandwidth modems, cable/DSL, T1 and related technologies, Wi-Fi, GPRS, any new fourth generation communication platforms, and any combination of these network technologies.

The server can be located remotely or in the same location as the automated devices. The server can be communicatively connected to the communications network. The server can feature communications software installed thereon that is capable of receiving control instructions in a third data stream from the control device and transmitting the control instructions to the computer in a fourth data stream over the communications network.

The translation software installed on the computer can be bidirectional in nature so as to be capable of translating the fourth data stream received from the server into a fifth data stream that is readable by the automated device. The fifth data stream is transmitted by the computer to the electronic automation device of the automated device to control one or more controllable features of the automated device. The interface can transmit both the first and fourth data streams between the automated device and the computer.

The control device can be communicatively connected to the server via the communications network. The control device can be a land-line telephone, a cellular telephone, a smart phone, a car navigation system, an interactive voice response system, a personal digital assistant, and a computer. The smart phone can be a cellular telephone device such as, for example, the iPhone™ made by Apple, the G1™ phone marketed by Google or the Blackberry Storm™ made by Research In Motion.

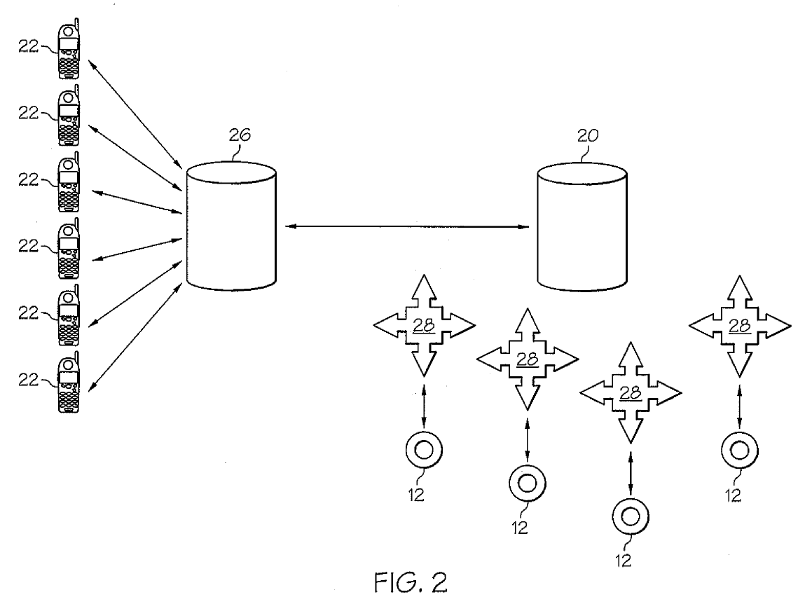

In embodiments using an interactive voice response system (IVR) 26 such as, for example, the embodiment shown in FIG. 2, multiple users can control and monitor remote automated devices 12 via one central server 20 that features the interactive voice response system 26 communicatively connected thereto. Using the IVR 26 and the system 10, the multiple users can simultaneously access the system to monitor and control multiple automated devices 12 located in multiple remote locations, e.g., multiple homes 28. The IVR can be connected to the remote electronic device control and monitoring system, e.g., the computer to which the automated devices are connected, by virtue of the communicative connection between the IVR and the server of the system. The interactive voice response system can provide one or multiple phone numbers, which may permit multiple users to simultaneously and securely log in to the system and control and monitor the users' remote automated devices. In an exemplary embodiment, the interactive voice response system can feature a single telephone number that can be dialed simultaneously by multiple users to access the system. In this manner, users may utilize the system, for example, to turn lights in a home on and off, to change the temperature setting on a thermostat, and to check the status of an over to determine whether the power to the over was inadvertently left on. The interactive voice response system can be capable of receiving and translating voice commands or control instructions provided by a user over a fixed phone line, a cellular phone line, or a voice over internet protocol (VoIP) telephone into a data stream that is transmittable to and readable by the server. Using the interactive voice response system as the control device, from virtually any remote location, the user can interact with the system to remotely control and monitor automated devices located in the user's home, business, rental property, vacation home or any other remote location via a central phone number. The system can also be used to control and monitor the automated devices in the home or property of another person, e.g., automated devices in the home of an elderly relative.

The interactive voice response system can be installed on the server communicatively connected to the communications network, e.g., a central server connected to the Internet. In one embodiment, the interactive voice response system can be installed on the same server as a central server for remote electronic device control, home automation, home security, remote business monitoring, elderly care or medical monitoring, or a server contemplated for any other feasible remote electronic device monitoring purpose. In another embodiment of the system, the interactive voice response system can be installed on a server that can communicate with the system for remotely controlling and monitoring the automated devices communicatively connected to the system.

Software of the interactive voice response system can feature an algorithm written to securely integrate the interactive voice response system with the remote control and monitoring system. With this connection between the remote control and monitoring system and the interactive voice response system, users can access both current and future functionality of the two systems via other access methods such as, for example, web browsers, cellular phones, and personal digital assistants, which can be designed to be accessible via the interactive voice response system.

The invention also features methods for remotely monitoring and controlling automated devices. The methods described herein can be used to monitor and control a home, apartment, or building and many of the electric and electronic devices contained therein from a remote location.

The method can be used to take a proprietary localized home automation compatible device, home control tool, or home automation software, including those having a standard web interface, and creating a secure, bidirectional communication protocol capable of being transmitted to dynamic graphic controls, third-party platforms, car navigation systems delivered via low-band or broadband connections, Wi-Fi, GPRS or any new communication method as widgets, Java or Active-X controls, XML data stream, VXML data stream, dynamic. HTML code, rich internet applications or WAP-enabled (cell phone) protocol. In embodiments of the method that include an interactive voice response system, additional communication methods, communication software and communication hardware are not necessarily used. The system can act as a universal platform with the ability to translate, integrate and read/write any proprietary formats creating a unified, secure platform for the bi-directional usage of the control features of the method and related systems.

Using the method, the user can monitor and manage all aspects of a home, apartment, building, or other space such as, for example, the alarm system, appliances, home audio and entertainment equipment, from secure controls that can be integrated into websites, online portals and cell phones allowing for continuous and remote access.

In one step of the method, a device featuring an automation system can be communicatively connected to a computer co-located in a first location. The computer can include control software installed thereon that is capable of translating and transmitting bi-directional data streams transmitted from the automation system to a server and from the server to the automation system.

In another step of the method, the computer can be communicatively connected to the server via a communications network. The server can be remotely located in a second location. The server may feature communications software installed thereon that is capable of receiving control instructions submitted by an access (or control) device and transmitting those control instructions to the computer. The communications software may translate these control instructions when the data stream transmitted by the access device to the server is in a language that is not readable by the computer. In an exemplary embodiment, the translation features of the control software of the computer can perform any necessary translation of the data stream.

In still another step of the method, control instructions can be provided to the server using the access device that is communicatively connected to the server via the communications network. In one embodiment, the access device can be used to access a website that includes control features capable of controlling the device. In another embodiment, the access device can be used to access an interactive voice response system that includes control features capable of controlling the device. In still another embodiment of the method, a plurality of access devices may be used to access either a website or an interactive voice response system.

In still another step of the method, the control instructions can be transmitted from the server to the computer using the communications software.

In yet another step of the method, the transmitted control instructions can be received from the server by the computer.

In yet another step of the method, the control instructions can be analyzed using the control software installed on the computer.

The automation system can then be instructed to activate or deactivate a control feature of the device.

The method can be used to remotely monitor a dwelling place or a building other than a dwelling place using the access device. The method can also be utilized by a user to monitor changes in the status of a control feature of one or more of the automated devices and to alert the user to any such status changes. For example, the method can be used to send an alert from an automated device such as, for example, a flood detector, to the user, e.g., an SMS message to a cellular telephone, that a basement in a home or other building has flooded. In another example, a door sensor can send an alert via automated telephone call or e-mail to the user that an outside access door of the user's home has been opened.

Features of the device that can be controlled using the methods described herein include, without limitation, a power supply setting, a volume setting, a brightness setting, the timing of the device, a television channel setting, a radio station setting, a temperature setting, a humidity setting, and a locking and unlocking of the device.

The method can be utilized with various home automation technologies including, without limitation, wireless, wired, and virtual automation technologies that can be connected to various automation systems. These automation systems are then be connected to a gateway box, e.g., the computer, via wireless, wired, or virtual communication linkage. The gateway box can translate data streams produced by all of these disparate resources into one secure data stream to be published to a main server via the Internet. Many locations containing the systems can be connected to the main server The main server can then deliver an interactive user experience via access methods utilizing the access (or control) devices described above.

The methods and systems described herein can be used by a single user to control, monitor, and receive alerts related to automated devices located in multiple locations. For example, the user can use the system to monitor and control automated devices in multiple homes, such as in the case of a property manager who may have the need to monitor and receive alerts from devices located in a plurality of homes or other locations.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for remotely controlling and monitoring automated devices, comprising:
an automated device generating a first data stream;
a computer to which the automated device is communicatively connected;
a communications network to which the computer is communicatively connected;
a server communicatively connected to the communications network; and
a control device communicatively connected to the server via the communications network.

2. The system of claim 1, wherein the automated device is selected from the group consisting of: an electrical device and an electronic device.

3. The system of claim 1, wherein the computer comprises software to translate the first data stream transmitted to the computer by the automated device into a second data stream that is transmitted to the server via the communications network.

4. The system of claim 1, wherein the server comprises communications software capable of receiving control instructions in a third data stream from the control device and transmitting the control instructions to the computer in a fourth data stream.

5. The system of claim 1, wherein the computer comprises control software capable of translating the fourth data stream into a fifth data stream that is readable by the automated device.

6. The system of claim 1, wherein the automated device is communicatively connected to the computer via an interface that is communicatively connected to the computer and that is capable of bi-directional transmission of the first and fourth data streams.

7. The system of claim 1, wherein the automated device comprises an electronic automation device capable of receiving control instructions from the computer.

8. The system of claim 1, wherein the automated device is selected from the group consisting of: a lamp, a light fixture, a lighting system, a home security system, an alarm system, a thermostat, a climate control system, a refrigerator, a freezer, an oven, a stove, an electric range, a hot tub, a jacuzzi, a swimming pool, a pool heater, a dishwasher, an iron, a washing machine, a drying machine, any other suitable home appliance, a television, a DVD player, a CD player, a home stereo system, a radio, an alarm clock, an answering machine, a digital video recorder, a VCR, a security camera, a personal computer, a cable box, a receiver, a digital television receiver, an electronic door lock system, a garage door control system, a security gate system, a medical monitoring system, and a battery-powered device.

9. The system of claim 1, wherein the control device is at least one device selected from the group consisting of: a land-line telephone, a cellular telephone, a smart phone, a car navigation system, an interactive voice response system, a personal digital assistant, and a computer.

10. The system of claim 1, wherein the communications network is selected from at least one of the group consisting of: an intranet, a virtual private network (VPN), a local area network (LAN), a wide area network (WAN), a global area network (GAN), the Internet, and a cellular telephone network.

11. A system for remotely controlling and monitoring automated devices, comprising:
(a) an automated device generating a first data stream;
(b) a computer to which the automated device is communicatively connected;
(c) a communications network to which the computer is communicatively connected;
(d) a server communicatively connected to the communications network;
(e) an interactive voice response system communicatively connected to the server and capable of receiving and translating audio instructions into a second data stream transmittable to and readable by the server;
(f) a telecommunication control device communicatively connected to the interactive voice response system via the communications network and capable of receiving and transmitting audio instructions to the interactive voice response system.

12 The system of claim 11, wherein the telecommunication control device is selected from at least one of the group consisting of: a fixed phone line, a cellular phone line, and a voice over internet protocol (VoIP) telephone.

13. A method for remotely monitoring and controlling automated devices comprising the steps of:
(a) communicatively connecting a device comprising an automation system to a computer co-located in a first location, wherein the computer comprises control software;
(b) communicatively connecting the computer to a server via a communications network, the server being remotely located in a second location, wherein the server comprises communications software;
(c) providing control instructions to the server using an access device that is communicatively connected to the server via the communications network;
(d) transmitting the control instructions from the server to the computer using the communications software;
(e) receiving the transmitted control instructions from the server by the computer;
(f) analyzing the control instructions using the control software installed on the computer; and
(g) instructing the automation system to activate or deactivate a control feature of the device.

14. The method of claim 13, wherein the method further comprises the step of:
(h) using the access device to access a website comprising control features capable of controlling the device.

15. The method of claim 13, wherein the method further comprises the step of:
(i) using the access device to access an interactive voice response system comprising control features capable of controlling the device.

16. The method of claim 13, wherein the method further comprises at least one step selected from the group consisting of:
(j) monitoring a dwelling place remotely using the access device; and
(k) monitoring a building other than a dwelling place using the access device.

17. The method of claim 13, wherein the method further comprises at least one step selected from the group consisting of:
(l) controlling a power supply setting of the device;
(m) controlling a volume setting of the device;
(n) controlling a brightness setting of the device;
(o) controlling the timing of the device;
(p) controlling a television channel setting of the device;
(q) controlling a radio station setting of the device;
(r) controlling a temperature setting of the device;
(s) controlling a humidity setting of the device; and
(t) controlling a locking and unlocking of the device.
